(19) United States
(12) Patent Application Publication
(10) Pub. No.: US 2015/0128267 A1
(43) Pub. Date: May 7, 2015

(54) CONTEXT-AWARE NETWORK FORENSICS

(71) Applicant: MCAFEE, INC., Santa Clara, CA (US)

(72) Inventors: Bikram Kumar Gupta, Sunnyvale, CA (US); Arun Shankar, Bangalore (IN)

(21) Appl. No.: 14/126,332

(22) PCT Filed: Nov. 6, 2013
(86) PCT No.: PCT/US2013/068779

§ 371 Date: Dec. 13, 2013

(51) Int. Cl. H04L 29/06

(52) U.S. Cl. CPC H04L 63/145
USPC 726/23

(57) ABSTRACT

Systems and methods for management of security events and their related forensic context are disclosed. Network forensics involves monitoring and analyzing data flows in a network to assist security analysts to review, analyze and remove a security threat. Security threats in a network environment are generally detected by one or more devices on the network. If a security threat is determined to be severe or significant enough, a security event corresponding to the security threat is often created and stored in the system. To assist in future review and analysis of security threats, timely and relevant context information about network security events may be obtained and stored along with each security event. The forensic context may be accessible to security administrators viewing the security events to provide detailed information about the circumstances surrounding a security event.

### TECHNICAL FIELD

This disclosure relates generally to network security management and in particular to systems and methods for conducting network forensics.

### BACKGROUND

Some amount of security risk is inherent when transferring digital data between different computers and/or computer networks. Computer networks that interact with other networks are constantly exposed to malware, or malicious software, such as viruses, worms, and Trojan horses, which are built to infiltrate every level of the computer software architecture. In order to detect such security threats and prevent possible damage to devices on the network, network traffic may be monitored and/or later analyzed by a security administrator. Such monitoring and analysis of network traffic is sometimes referred to as network forensics. Performing forensics on a network wide basis is valuable, as an attacker might be able to erase all log files on a compromised host and thus network-based evidence might be the only evidence available for forensic analysis.

One of the first steps in performing network forensics for security purposes generally involves monitoring a network for anomalous traffic and identifying intrusions. To be able to later analyze forensics data on the network, many networks store all or most data flows that pass through the network. For large networks, this could mean storing many terabytes of data per month which may quickly lead to running out of storage space. Moreover, security analysts often have to search the data to be able to analyze a security risk. Because of the amount of data involved, each query made may take a long time to process, as it is often difficult and time consuming to mine through a large amount of data to perform a search.

To resolve these issues, some network systems have begun summarizing the data they store. Instead of storing all data flows, these networks store a summary of high level information about the data, such as byte numbers and the like over the long term. Storing only a summary of the data flow can help resolve the issues of storage space limitations and searching through a large amount of data. This approach, however, is less than ideal as it results in the system losing a lot of important information about the data flows. The information lost may be useful or necessary for the security analysis to properly identify and remove a security threat. The following disclosure addresses these and other issues.

### BRIEF DESCRIPTION OF THE DRAWINGS

FIG. 1 is a block diagram illustrating a network architecture infrastructure according to one or more disclosed embodiments.

FIG. 2 is a block diagram illustrating a device which could be used as part of a system to execute the context-aware network forensics approaches described herein according to one or more disclosed embodiments.

FIG. 3 is a block diagram illustrating a system which could be used to execute the context-aware network forensics approaches described herein according to one or more disclosed embodiments.

FIG. 4 illustrates the fields of a flow record table which could be used in one or more disclosed embodiments.

FIG. 5 illustrates the fields of a forensic context table and how they relate to the fields of a flow record table in one or more disclosed embodiments.

FIG. 6 illustrates a user interface screen which could be used to change parameters of forensic context stored according to one or more disclosed embodiments.

FIG. 7 illustrates an example of recursive forensic context stored according to one or more disclosed embodiments.

FIG. 8 illustrates a user interface screen which could be used to view and manage security related information according to one or more disclosed embodiments.

FIG. 9 illustrates the fields of a flow record table for a high risk host which could be used in one or more disclosed embodiments.

FIG. 10 illustrates a user interface screen which could be used to view and manage stored forensic context according to one or more disclosed embodiments.

### DESCRIPTION OF DISCLOSED EMBODIMENTS

Network forensics involves monitoring and analyzing data flows in a network to assist security analysts to review, analyze and remove a security threat. Security threats in a network environment are generally detected by one or more devices on the network. For each security threat or risk detected, a security event is often created and stored in the system. In many cases, the significance of a security event is not immediately recognized at a network management computer or through review by an analyst. At the same time, many security events contain only limited information about the context in which they occur. Context information is fleeting, and by the time an external application, or user, or a security analyst decides to issue a query, it may already have been lost. These issues can be solved by collecting timely and relevant context information about network security events and storing such context information with the security events. By detecting security events and storing relevant context information along with the security events, this approach eliminates the need for storing and mining through a large amount of data and thus provides important forensics data efficiently and effectively.

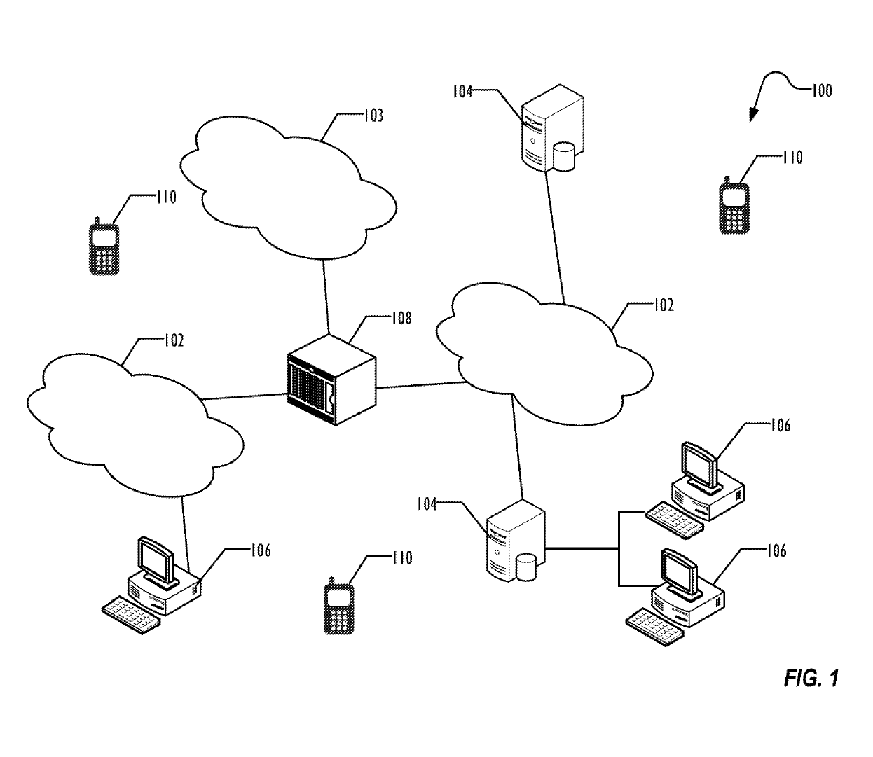

Referring now to FIG. 1, infrastructure 100 is shown schematically. Infrastructure 100 contains computer networks 102 which may include many different types of computer networks available today, such as the Internet, a corporate network, or a Local Area Network (LAN). Each of these networks can contain wired or wireless devices and operate using any number of network protocols (e.g., TCP/IP). Networks 102 are connected to gateways and routers (represented by 108), end user computers 106 and computer servers 104. Also shown in infrastructure 100 is a cellular network 103 for use with mobile communication devices. As is known in the art, mobile cellular networks support mobile phones and many other types of devices (e.g., tablet computers not shown). Mobile devices in the infrastructure 100 are illustrated as mobile phones 110.

In a network such as displayed in FIG. 1, data flows can be monitored and analyzed for forensics purposes. One or more software programs or appliances may be used to monitor network packets in all data flows in the network, detect security threats in the data flows, create a security event based on a detected threat, gather forensics information relating to the security event and store such information along with the security event for later access and/or analysis.

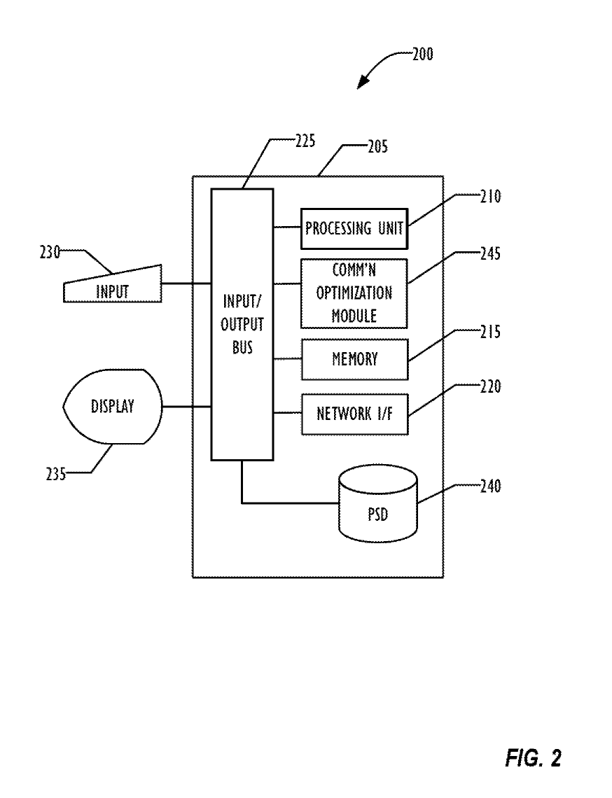

Referring now to FIG. 2, an example processing device 200 for use in performing network forensics techniques according to one embodiment is illustrated in block diagram form. Processing device 200 may serve as processor in a mobile phone 110, gateway or router 108, client computer 106, or a server computer 104. Example processing device 200 comprises a system unit 205 which may be optionally connected to an input device for system 230 (e.g., keyboard, mouse, touch screen, etc.) and display 235. A program storage device (PSD) 240 (sometimes referred to as a hard disk, flash memory, or non-transitory computer readable medium) is included with the system unit 205. Also included with system unit 205 is a network interface 220 for communication via a network (either cellular or computer) with other mobile and/or embedded devices (not shown). Network interface 220 may be included within system unit 205 or be external to system unit 205. In either case, system unit 205 will be communicatively coupled to network interface 220. Program storage device 240 represents any form of non-volatile storage including, but not limited to, all forms of optical and magnetic memory, including solid-state, storage elements, including removable media, and may be included within system unit 205 or be external to system unit 205. Program storage device 240 may be used for storage of software to control system unit 205, data for use by the processing device 200, or both.

System unit 205 may be programmed to perform methods in accordance with this disclosure. System unit 205 comprises one or more processing units, input-output (I/O) bus 225 and memory 215. Access to memory 215 can be accomplished using the communication link 225. Communication link 225 may be any type of interconnect including point-to-point links and busses. Processing unit 210 may include any programmable controller device including, for example, a mainframe processor, a mobile phone processor, or, as examples, one or more members of the INTEL ATOM®, and INTEL CORE® processor families from Intel Corporation and the Cortext® and ARM® processor families from ARM Limited Corporation. (INTEL, INTEL ATOM, and CORE are trademarks of the Intel Corporation. CORTEX is a registered trademark of the ARM Limited Corporation. ARM is a registered trademark of the ARM Limited Company). Memory 215 may include one or more memory modules and comprise random access memory (RAM), read only memory (ROM), programmable read only memory (PROM), programmable read-write memory, and solid-state memory. As also shown in FIG. 2, system unit 205 may also include a communication optimization module 245, which may be implemented in firmware to aid in the performance of the communication optimization techniques described herein.

As noted above, embodiments of the inventions disclosed herein may include software. As such, we shall provide a description of common computing software architecture. Like the hardware examples, the software architecture discussed here is not intended to be exclusive in any way but rather illustrative.

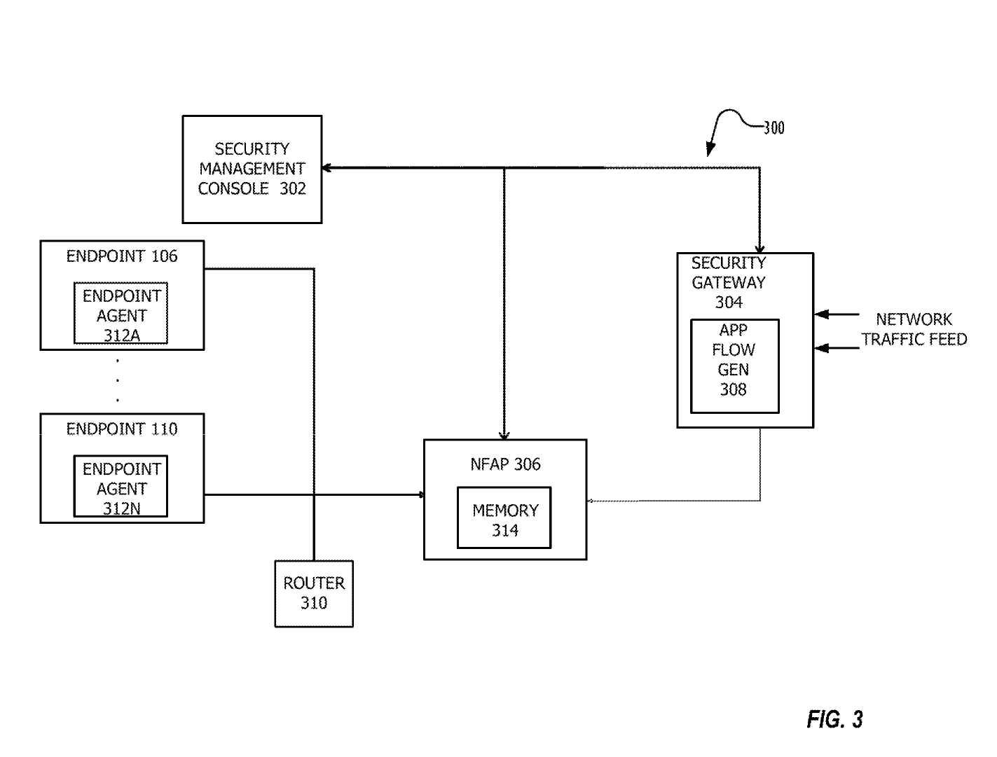

We now turn to a discussion of various embodiments for performing context aware network forensics. Referring to FIG. 3, a block diagram 300 illustrates one example of a system implementing context aware network forensics. This system includes a security management console 302 which, in one embodiment, is a management tool that provides information technology (IT) administrators with a way to centrally manage security of an entire network infrastructure by providing a single point of visibility into the network's security posture. In one embodiment, the security management console 302 is a software program installed on a device on the network or in the cloud.

As part of its security management options, the security management console 302 may provide a user with the option to review, analyze and evaluate security threats. To do so, the security management console 302 may include capabilities for performing and reviewing network forensics context associated with each security threat. This may be done through connections with and data received from a security gateway 304 and a network flow analysis platform (NFAP) 306. In one embodiment, the security management console 302 is configured to manage both the security gateway 304 and the NFAP 306 and is thus a common management console across both.

In one embodiment, the security gateway 304 is an appliance responsible for performing Deep Packet Inspection (DPI). The security gateway 304 receives traffic feeds from the network and monitors and inspects the data flows in the network to search for viruses, spam, data loss, intrusions, or other potential security threats. In one embodiment, the security gateway 304 is an intrusion prevention system (IPS) which monitors network activities for malicious activity. Alternatively, the security gateway 304 may be a firewall.

Once the security gateway 304 detects a potential security threat, it may determine whether it should designate the threat as a security event. In one embodiment, this decision is made based on the severity level of the security threat. The severity levels may be designated as low, medium, high, and critical or any other desired designation. In one embodiment, if the security threat passes a specific threshold of severity level, the threat will be designated as a security event. For example, security threats having severity levels of medium and higher may be designated as security events, while threats having a low severity level may be ignored. The severity levels and the threshold at which threats are designated as security events may be predetermined or may be set by an administrator as will be discussed in more detail below.

The level of severity of a security threat is determined, in one embodiment, based on policies enforced by the security gateway 304. The policies may contain a list of types of security threats and their associated severity level. The types of security threats in the list and their associated severity may be defined by a security gateway vendor (not shown). Alternatively, the types of security threats and/or their associated severity levels may be defined by an administrator.

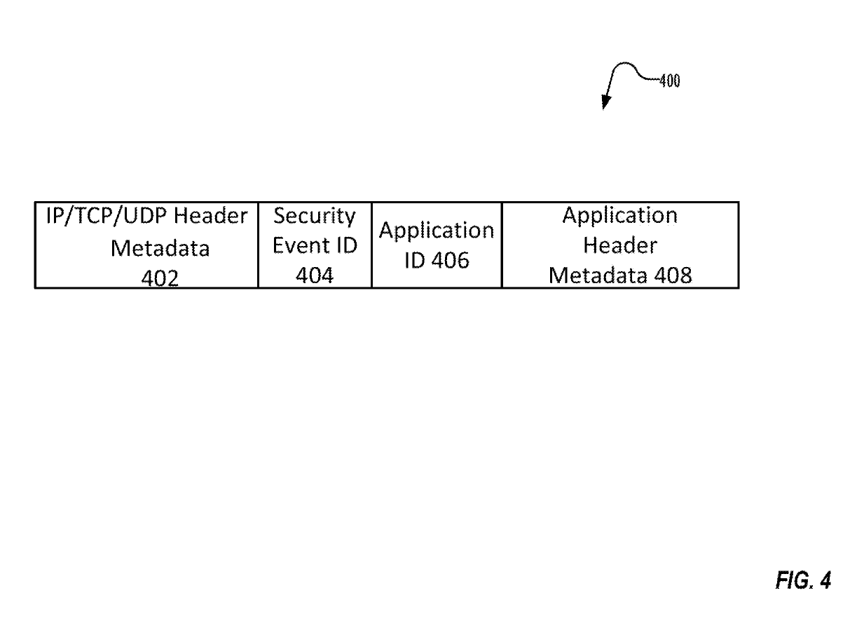

After a security threat is designated as a security event, an application flow generator 308 inside the security gateway 304 may generate an application flow record for the detected security event and assign a security event ID to the security event. FIG. 4 illustrates a representation of an application flow record 400 generated by the security gateway 304.

The flow record 400 includes a field 402 for IP/TCP/UPD header metadata. The field 402 may identify the type of protocol used by the flow data that caused the security event. For example, the field 402 may contain entries designating the types as Netflow, IPFLX, Jflow, or Sflow. The flow record 400 also includes a field 404 for recording the security event ID, and a field 406 for recording an application ID. The application ID may indicate what type of application caused the security threat. A field 408 of the flow record 400 may record the application's header metadata and/or header data relating to the protocol used by the security event. The application flow record 400 may include other fields. It should be noted, that in one embodiment, the application flow generator 308 generates an application flow record for every network flow, even if a security event is not detected for the flow. In such instances, the application flow record generated may have different fields than the ones shown in flow record 400.

In addition to generating an application flow record for the detected security event, the security gateway 304 is also configured to transmit the flow record to the NFAP 306. The NFAP 306 is, in one embodiment, a server-grade chassis for performing extensive mining of application flow records. Alternatively, the NFAP 306 can be a virtual appliance or a software module embedded inside the security gateway 304. According to one embodiment, the NFAP 306 is a Network Threat Behavior Appliance (NTBA). The NFAP 306 is generally responsible for processing of flow records and summarizing the network behavior over the long term. This summary includes, in one embodiment, network forensics context. To store such a summary, the NFAP 306 includes a memory 314. The memory 314 may include one or more memory modules and comprise hard disk, flash memory, random access memory (RAM), read only memory (ROM), programmable read only memory (PROM), programmable read-write memory, solid-state memory, or other desired type of storage media.

In prior art systems in which all data flows were stored to preserve network forensics information, the NFAP 306 would require a significant amount of storage capacities. Using a context aware network forensics approach, however, significantly decreases the amount of data that needs to be stored for forensics purposes and consequently decreases the amount of storage capacity required for the NFAP 306. For example, in one embodiment, using context aware network forensics approaches discussed in this disclosure reduces effective storage requirements by 90%. Thus, while a prior art NFAP may be able to store only one day of all flow records, using the approaches discussed in this disclosure may enable storing weeks of detailed forensics context without a need for backup space. This is advantageous in not only reducing costs, but also significantly improving the amount of time required for searching and accessing forensics records.

In order to provide comprehensive forensics data relating to a security event, in addition to receiving application flow information from the security gateway 304, the NFAP 306 may also receive some information from one or more endpoint agents 312A-312N. The endpoint agents 312A-312N are, in one embodiment, modules that run on endpoint devices such as endpoint user computer 106 and endpoint mobile phone 110 (see FIG. 1) and are configured to gather and send endpoint process data to the NFAP 306. The endpoint process data may include process information and associated metadata such as process names, associated DLLs and other heuristics that may enable detection of suspicious activity from the endpoints.

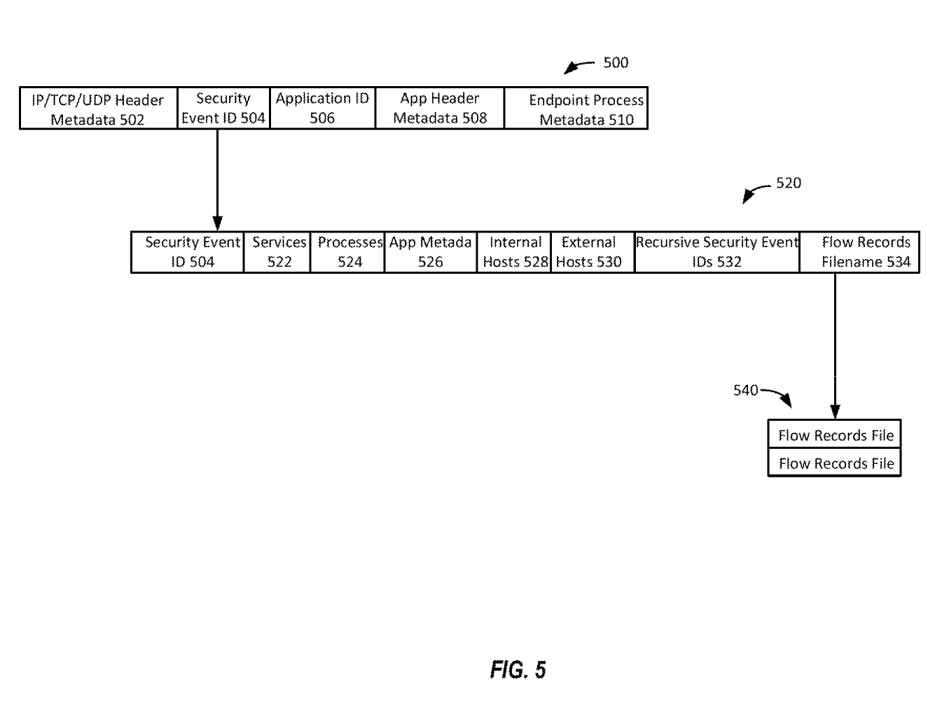

In addition to application flow data and process data, the NFAP 306 may also receive network flow data (e.g., Netflow, sFlow, J-Flow, IPFIX) from routers, such as a router 310 or from switches, firewalls, or other gateways in the network. The network flow data may include header metadata information (e.g., IP/TCP/UPD). After receiving all of this information, the NFAP 306 may examine the application flow record along with the endpoint process flow data and the network flow data to correlate all of the received information, remove duplicates, normalize matching flows and generate and store a flow record along with comprehensive forensics information for each security event. FIG. 5 illustrates example fields for such a flow record stored in memory 314 of the NFAP 306. As shown, in addition to the fields present in the flow record 400 (IP/TCP/UPD Header Metadata 502, Security Event ID 504. Application ID 506, and Application Header Metadata 508), the flow record table 500 includes a field 510 for recording endpoint process metadata. In addition to creating a record in the flow records table 500, the NFAP 306 is configured to generate a record in a forensics context table 520 for each security event.

The forensics context gathered and stored may include information about services that were launched during a specific time period before or after a security event for which data is being stored, metadata relating to applications accessed during the same time period, endpoint processes started, and internal host connections and external host connections during the same period. Additionally, raw data flow records relating to the security event may be gathered and stored in one or more flow records files.

One or more other types of forensics data may also be gathered and stored. For example, in one embodiment, the system identifies whether a security event is recursive and if so creates a link between the recursive event and other events to which it is related. An event may be identified as recursive when it occurs within a specified timeframe before or after another security event or when it shares certain characteristics with a previous event. For example, a scan that occurs within 30 minutes of a drive-by-download is likely a recursive event. A data leakage following a new suspicious process seen after a drive-by-download is also a recursive event which should be linked to the drive-by-download. When these events are linked as recursive events, forensic context relating to all of them may be accessed when one is selected.

In one embodiment, the forensics context data gathered is recorded in the forensics context table 520. The forensics context table 520 contains a number of fields for recording the various types of forensic context data. For example, a field 504 may be provided for recording the security event ID. The security event ID may act as a unique identifier for each security event that link its data from the flow records table 500 to the forensics context table 520. In one embodiment, the security event ID is a unique numeric identifier which can be used to refer to the same unique security event by the security gateway 304, NFAP 314, and security management console 302. Thus, the security event ID may act as a primary key for looking up and retrieving forensics context relating to each security event. In one embodiment, the security event ID may include a timestamp or similar indicator which identifies a unique security event at a particular time. In other embodiments, the security event ID may include an indicator that identifies the type of threat involved in the unique security event (e.g., drive-by-download, server exploit, port scan, etc.).

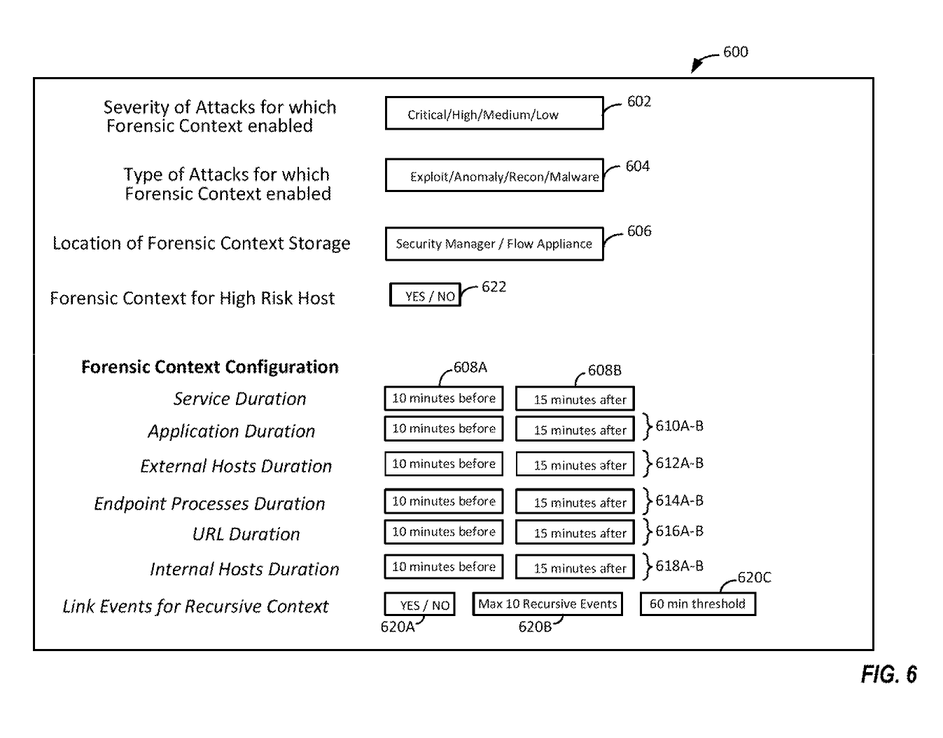

The forensics context table 520 may also include fields for services 522, endpoint processes 524, application metadata 526 (e.g., URLs, FTP user, SMTP addresses, etc.), internal host connections 528, and external host connections 530. A field 532 may be provided for recording Security Event IDs of related events in case of a recursive security event. Additionally, field 534 may record file names of one or more flow record files 540 that store raw flow records relating to the security event. The context stored in the forensics context table 520 may vary in different embodiments. In one embodiment, IT administrators may be provided with an option through a user interface of the SMC 302 to choose the type of forensics contexts stored for security events. One such embodiment is illustrated in FIG. 6.

The user interface 600 may include a selection box 602 for selecting the level of severity of security attacks for which forensic contexts should be stored. The severity level can be set as critical, high, medium or low or any other desired level. The interface 600 may also include a box 604 for selecting the type of attacks for which forensics context should be enabled, such as exploit attacks, anomaly, recon, malware, and the like. In one embodiment, only one type of security attack can be selected. In alternative embodiments, two or more types of security attacks can be selected at the same time. The user interface 600 also includes a box 606 for selecting the location at which the forensics context should be stored. The IT administrator can select either the security management console SMC 302 or the NFAP 306 for storing the forensics context. Alternatively, both could be selected to provide backup. A box 622 may also be provided to allow the administrator to choose if forensic context should be stored for high risk hosts. This is explained in more detail below.

The user interface 600 may also include options for configuring the length of time for which context data should be stored for each security event. For example, the user interface 600 provides boxes 608A and 608B for selecting the amount of time before (608A) and after (608B) the security event for which information relating to services used by the security threat should be stored. Similarly, boxes 610A and 610B provide options for selecting before and after time duration for storage of application related data, boxes 612A and 612B for selecting time duration for storage of external hosts information, boxes 614A and 614B for selecting time duration for storage of endpoint process information, boxes 616A and 616B for selecting time duration for storage of URL information, and boxes 618A and 618B for selecting time duration for storage of internal hosts information. In one embodiment, the duration of time may be chosen from options ranging from 180 minutes before to 1 minute before an event and 1 minute after to 180 minutes after an event. In an alternative embodiment, the IT administrator may be able to enter a desired amount of time for the before or after time duration in any of the boxes.

User interface 600 may also include a box 620A for choosing whether to link security events to enable access to recursive context. As discussed above, choosing to link different events as recursive provides the ability to build a timeline for security events. By building a timeline a user may be able to review other security events that occurred before and/or after a selected security event that may be related or caused by the same issue. This allows IT administrators to get a broader picture of what occurred in the network and may enable them to identify a source of the security breach and/or subsequent events it caused. When the Yes option is selected at box 620A to enable recursive context, box 620B may be used to select the maximum number of events that could be linked as recursive, and box 620C could be used to select a minimum time duration for looking for and linking events as recursive.

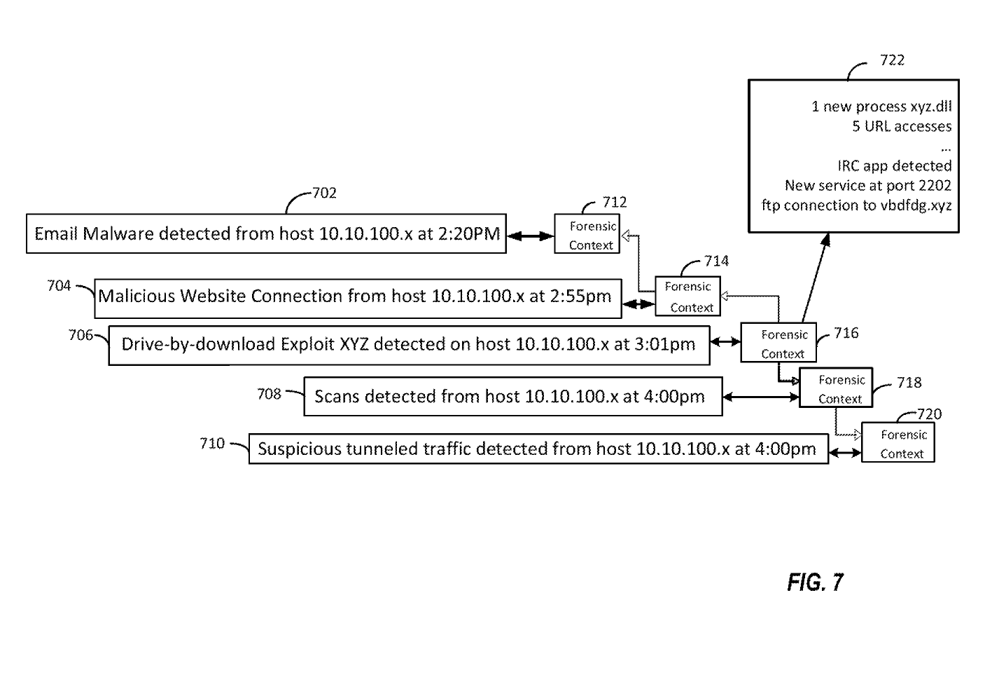

FIG. 7 provides an example for storing recursive context for security events. As can be seen, a security event 706 involving a drive-by-download exploit is detected on a particular host at 3:01 pm. The security event 706 along with its forensic context 716 are stored in the system. When recursive context is enabled, the system looks for security events that occurred within a selected time frame before and after each security event to link those events that seem to be related. In the example illustrated in FIG. 7, security event 702 having forensic contexts 712 and security event 704 having forensic context 714 occurred within 60 minutes before the security event 706 on the same host and are thus linked as recursive events. Similarly, security events 708 having forensic context 718 and security event 710 having forensic context 720 occurred within 60 minutes of the security event 706 on the same host and thus they are also linked as recursive events with the security event 706. Therefore, an administrator selecting to view the security event 706 may be presented with the security events 702, 704, 708, and 710 on the same screen. Alternatively, the administrator may be given an option to select whether to view the related recursive events.

FIG. 7 also provides an example of the type of forensic context stored and available for review for a security event. Box 722 illustrates some of the forensic context stored in relation to the security event 706, which is a drive-by-download exploit named XYZ detected on host 10.10.100.x. The forensic context stored for this event identifies that one new process xyz.dll was detected, 5 URL accesses occurred, IRC application was detected, new service was established at port 2202, and a new ftp connection to vbdfdg.xyz was made. By looking at this information, an administrator can determine whether or not a security event was in fact a security threat and if so the extent of leakage or damage done by the threat.

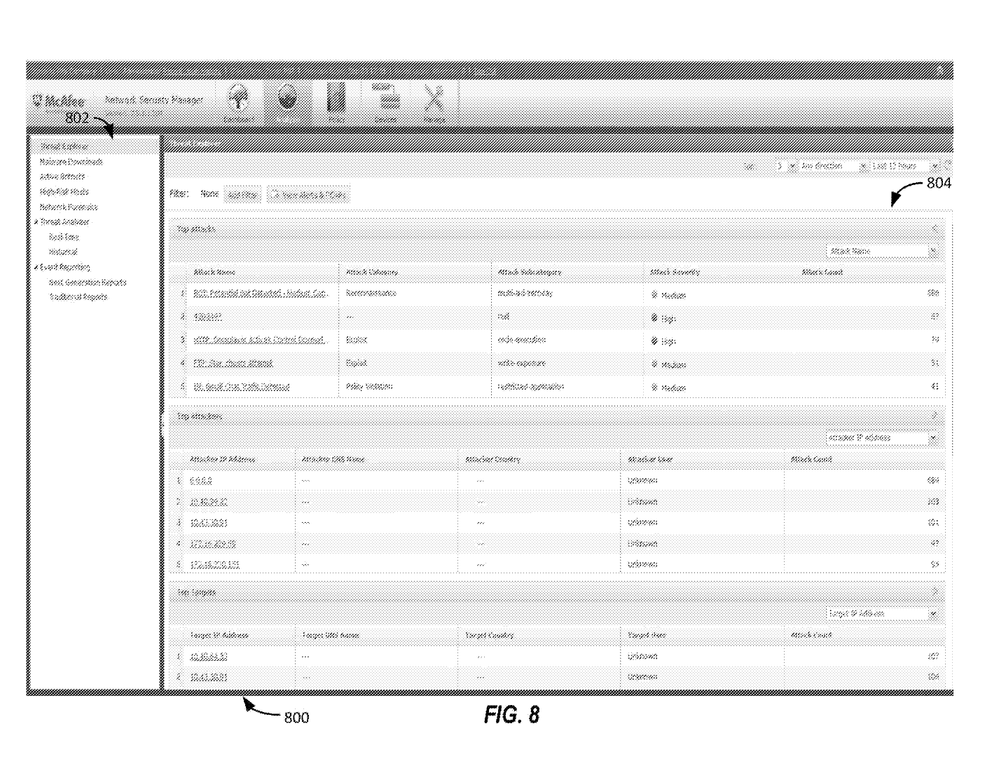

FIG. 8 illustrates an example user interface screen 800 provided by the SMC 302 that can be used to access and manage security threats and their related data. The user interface screen 800 includes a view pane 802 that provides a list of options for viewing security related information, such as Threat Explorer, Malware Downloads, Active Botnets. High-Risk Hosts. Network Forensics, Threat Analyzer and Event Reporting. Selecting each one of these options brings up a different screen portion 804 that displays security related information specific to the option selected. For example, as can be seen in the user interface 800, selecting the Threat Explorer option brings up the screen portion 804 which categorizes and lists security threats in the network. The threats are categorized in the screen portion 804 under the categories of Top Attacks, Top Attackers, and Top Targets.

User interfaces provided by the SMC 302 (see FIG. 3) can be used to enable administrators to view and manage security events and their related forensics contexts. In one embodiment, the administrator may be able view, delete, or auto-acknowledge security events on the screen. In one configuration, forensic contexts are managed as part of the security events' life-cycle. Thus, when an action is taken on a security event, the same action may automatically be taken on that event's forensic context. For example if an event is deleted, its forensic context is also automatically deleted. The user interface can communicate through the SMC 302 with the NFAP 306 (see FIG. 3) to manage security events stored on the NFAP 306.

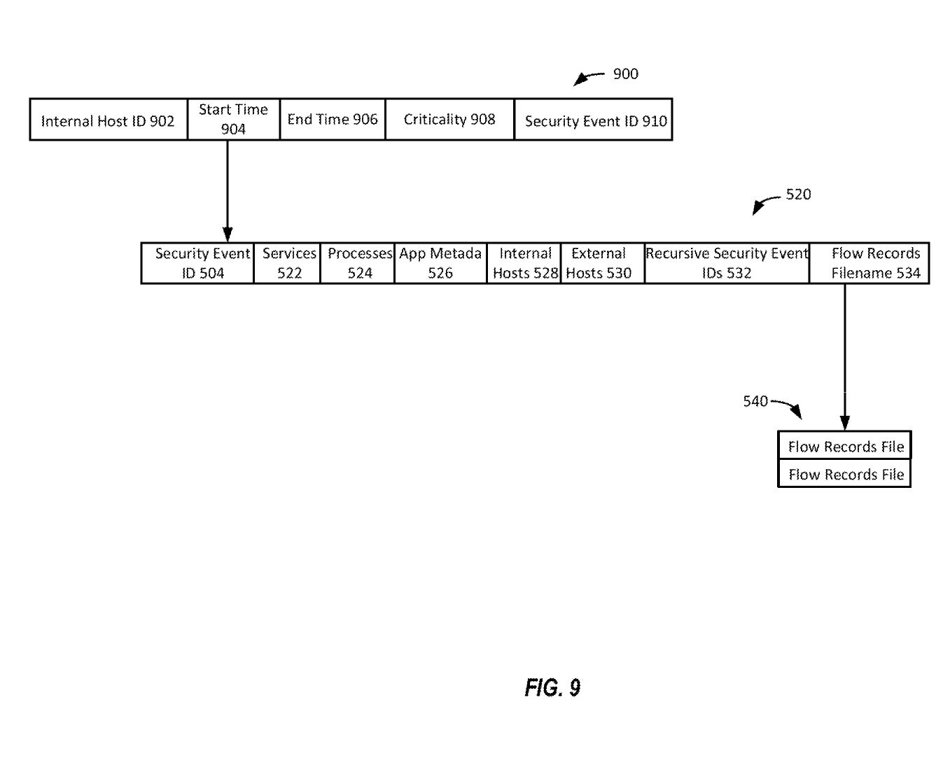

A user interface provided by the SMC 302 may also be used to search for security events by keyword, host, URL, or other criteria. Searching for a URL allows administrators to look for, review, and analyze events at a bad URL or malicious program. Allowing administrators to search for a host enables them to select a host to view security events related to that host. This is particularly useful for high risk hosts. A host may be labeled as high risk when it exhibits certain behavior such as, malicious file downloads, accessing improper websites, scanning internal servers, bittorrent downloads, etc. during a specific time period. To determine if a host is risk host, an algorithm, generated internally or supplied by third party modules, may be used. In one embodiment, the identification of high risk hosts is performed by the NFAP 306. The NFAP 306 may include algorithms for monitoring the behavior of individual hosts based on security events, traffic profiles, services, application reputation, connection reputation, and the like. This information may be gathered and analyzed by the NFAP 306 to derive a host threat factor (HTF). The HTF may then be used to determine if a host is high risk. Any other desired technique for identifying a high risk host may be used. Once the host is identified as high risk, the system may begin storing extended forensic context for security events occurring at that host. In one embodiment, the NFAP 306 may begin collecting and storing flow data relating to the host in an internal high risk host table 900, as illustrated in FIG. 9.

Table 900 may include a field 902 for an internal host ID. The internal host may be an ID designated and used internally for the high risk host. A start time field 904 may be used to record the time at which the host becomes labeled as a high risk host. At the beginning of the start time, the NFAP 306 begins collecting and storing forensic context for the high risk host in the forensic context table 520. Thus, during the period when the host is labeled as high risk, the NFAP 306 may collect complete forensic context for the host. As the behavior of hosts change from time to time, a high-risk host may become normal after a certain period of time. When that happens, the NFAP 306 may trigger a security event that marks the host becoming normal. An end time field 906 of the table 900 may then be used to record the time at which the host stopped being a high risk host. A field 908 may also be provided to record the level of criticality of the host and a security event ID field 910 may be used to record the security event ID associated with the event of the host becoming high risk or the host becoming normal again. By reviewing security events and their related forensics context occurring at a high risk host, the administrator may be able to determine the root cause of problems at the host and thus may be able to identify a solution for the problem.

In one embodiment, a user interface may also be provided to select an option for storing extended forensic context for high risk hosts. For example, the administrator may be able to select to store forensic context for a longer period of time for security events occurring at high risk hosts. Alternatively, the system may be pre-configured to store extended forensic context for high risk hosts.

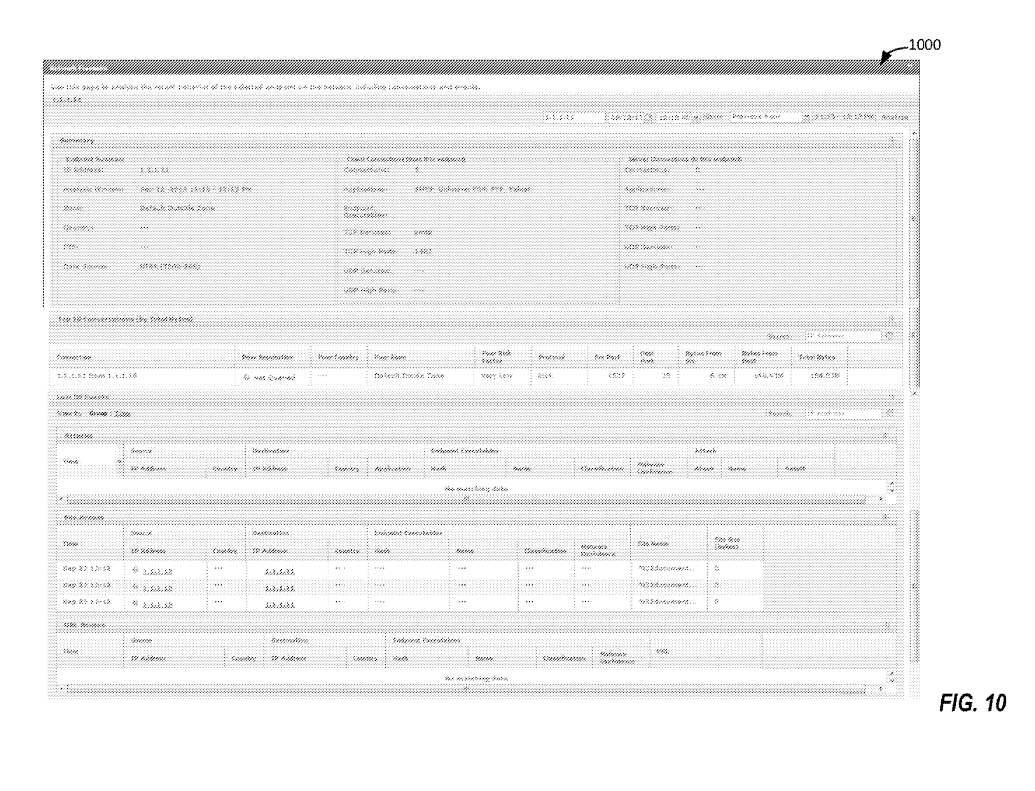

A user interface provided by the SMC 302 may also be used to choose storing forensic data and forensic context for a given endpoint device. When such an option is chosen, the stored forensic data can be viewed on a user interface screen such as the user interface screen 1000 of FIG. 10. As can be seen, the user interface 1000 provides a summary information for the endpoint which includes a summary of connections from the endpoint and server connections to the endpoint. The user interface 1000 also provides a summary of security events (Last 50 Events), Top 10 connections, and file and URL accesses. The user interface may also provide options to purge forensic context data automatically or manually.

### EXAMPLES

The following examples pertain to further embodiments. Example 1 is a non-transitory computer readable medium comprising instructions stored thereon to cause one or more processors to: monitor flow of data in a network at one or more network devices configured to perform network traffic monitoring, identify at least one security threat in the flow of data, obtain network forensics context relating to the at least one security threat, and store the at least one security threat and the related network forensics context in a memory.

Example 2 includes the subject matter of example 1, further comprising instructions to cause the one or more processors to provide access to the forensics context upon access to the at least one security threat.

Example 3 includes the subject matter of example 1, further comprising instructions to cause the one or more processors to assign a security event ID to the at least one security threat.

Example 4 includes the subject matter of example 3, wherein data relating to the at least one security threat is stored in a flow record table, the flow record table comprising a field for the security event ID.

Example 5 includes the subject matter of example 4, wherein the flow record table further comprises a field for header metadata and a field for application ID.

Example 6 includes the subject matter of example 4, wherein the forensic context is stored in a forensic context table containing a field for the security event ID.

Example 7 includes the subject matter of example 6, wherein the security event ID assigned to the at least one security event is used for the forensic context relating to the at least one security event.

Example 8 includes the subject matter of examples 1 or 2, wherein the forensic context comprises one or more of application metadata, endpoint processes, external host connections, internal host connections, and data flow records stored in one or more flow record files.

Example 9 includes the subject matter of any of examples 1-7, further comprising instructions to cause the one or more processors to determine if the security threat is a security event.

Example 10 includes the subject matter of any of example 1-7, wherein network forensic context is obtained for the security threat, only when the security threat is determined to be a security event.

Example 11 includes the subject matter of example 9, further comprising instructions to cause the one or more processors to determine if the security event is recursive and to store recursive forensic context for the security event if it is determined to be recursive.

Example 12 is a network device configured to perform analysis of network traffic, the network device comprising: one or more processors, one or more network communication interfaces, and a memory communicatively coupled to the one or more processors, wherein the memory stores instructions to cause the one or more processors to: receive network packets from the one or more communication interfaces, the network packets associated with a network flow of data, monitor the flow of data to identify at least one security threat, obtain network forensics context relating to the at least one security threat, and store the at least one security threat and the related network forensics context in the memory.

Example 13 includes the subject matter of example 12, wherein monitoring of the flow of data comprises deep packet inspection.

Example 14 includes the subject matter of example 12, wherein the forensic context comprises one or more of application metadata, endpoint processes, external host connections, internal host connections, and data flow records stored in one or more flow record files.

Example 15 includes the subject matter of example 12, wherein the instructions further cause the one or more processors to enable a user to determine types of forensics context stored for the at least one security threat.

Example 16 includes the subject matter of example 12, wherein the instructions further cause the one or more processors to provide a user interface, wherein the user interface can be used to view the at least one security threat and the stored forensic context.

Example 17 includes the subject matter of example 16, wherein the user interface can be used to take an action with respect to the at least one security threats.

Example 18 includes the subject matter of example 17, wherein any action taken with respect to the at least one security threat is also taken with respect to the security threat's forensic context.

Example 19 includes the subject matter of example 12, wherein the instructions further cause the one or more processors to determine if the security threat is a security event and only obtain forensic context relating to the security threat if it is determined that the security threat is a security event.

Example 20 is a method, comprising the steps of: receiving network packets from one or more communication interfaces at a device configured to perform network traffic monitoring, the network packets associated with a network flow of data, monitoring the flow of data to identify at least one security threat, obtaining network forensics context relating to the at least one security threat, and storing the at least one security threat and the related network forensics context in a memory.

Example 21 includes the subject matter of example 20, further comprising the steps of providing a user interface screen for viewing the at least one security threat and the forensic context.

Example 22 includes the subject matter of example 21, wherein the user interface is configured to enable management of the at least one security threat and the forensic context.

Example 23 includes the subject matter of example 20, further comprising the steps of determining if the at least one security threat is a security event and obtaining forensic context relating to the at least one security and storing the at least one security threat and the related forensic context only if the security threat is determined to be a security event.

Example 24 includes the subject matter of example 20, further comprising the steps of determining if the security threat is a security event.

Example 25 includes the subject matter of example 20, wherein the network forensic context is obtained for the security threat only when the security threat is determined to be a security event.

Example 26 includes the subject matter of example 20, wherein the security threat is determined to be a security event if a level of severity of the security threat is above a certain threshold level.

Example 27 includes an apparatus configured to perform analysis of network traffic, comprising: memory means, network communication interface means, and processing means, communicatively coupled to the memory means, wherein the memory means stores instructions to configure the processing means to: receive network packets from the network communication interface means, the network packets associated with a network flow of data, monitor the flow of data to identify at least one security threat, obtain network forensics context relating to the at least one security threat, and store the at least one security threat and the related network forensics context in the memory means.

Example 28 includes the subject matter of example 27, wherein monitoring of the flow of data comprises deep packet inspection.

Example 29 includes the subject matter of example 27, wherein the forensic context comprises one or more of application metadata, endpoint processes, external host connections, internal host connections, and data flow records stored in one or more flow record files.

Example 30 includes the subject matter of example 27, wherein the instructions further cause the processing means to enable a user to determine types of forensics context stored for the at least one security threat.

Example 31 includes the subject matter of example 27, wherein the instructions further cause the processing means to provide a user interface, wherein the user interface can be used to view the at least one security threat and the stored forensic context.

Example 32 includes the subject matter of example 31, wherein the user interface can be used to take an action with respect to the at least one security threats.

Example 33 includes the subject matter of example 32, wherein any action taken with respect to the at least one security threat is also taken with respect to the security threat's forensic context.

Example 34 includes the subject matter of example 27, wherein the instructions further cause the processing means to determine if the security threat is a security event and only obtain forensic context relating to the security threat if it is determined that the security threat is a security event.

Example 35 includes an apparatus, comprising: a memory, one or more processing units, and a non-transitory computer readable medium comprising computer executable instructions stored thereon to cause the one or more processing units to: receive network packets from the one or more network communication interfaces, the network packets associated with a network flow of data, monitor the flow of data to identify at least one security threat, obtain network forensics context relating to the at least one security threat, and store the at least one security threat and the related network forensics context in the memory.

Example 36 includes the subject matter of example 35, wherein monitoring of the flow of data comprises deep packet inspection.

Example 37 includes the subject matter of example 35, wherein the forensic context comprises one or more of application metadata, endpoint processes, external host connections, internal host connections, and data flow records stored in one or more flow record files.

Example 38 includes the subject matter of example 35, wherein the instructions further cause the one or more processing units to enable a user to determine types of forensics context stored for the at least one security threat.

Example 39 includes a system for performing analysis of network traffic, comprising: a memory, one or more network communication interfaces, and one or more processors, communicatively coupled to the memory, wherein the memory stores instructions to configure the one or more processors to: receive network packets from the one or more network communication interfaces, the network packets associated with a network flow of data, monitor the flow of data to identify at least one security threat, obtain network forensics context relating to the at least one security threat, and store the at least one security threat and the related network forensics context in the memory.

Example 40 includes the subject matter of example 39, wherein the forensic context comprises one or more of application metadata, endpoint processes, external host connections, internal host connections, and data flow records stored in one or more flow record files.

Example 41 includes the subject matter of example 39, wherein the instructions further cause the one or more processors to provide a user interface, wherein the user interface can be used to view the at least one security threat and the stored forensic context.

Example 41 includes the subject matter of example 41, wherein the user interface can be used to take an action with respect to the at least one security threats and any action taken with respect to the at least one security threat is also taken with respect to the security threat's forensic context.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process acts may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

1-25. (canceled)

26. A computer readable medium comprising instructions stored thereon to cause one or more processors to:
monitor flow of data in a network at one or more network devices configured to perform network traffic monitoring;
identify at least one security threat in the flow of data;
obtain network forensics context relating to the at least one security threat; and
store the at least one security threat and the related network forensics context in a memory.

27. The computer readable medium of claim 26, further comprising instructions to cause the one or more processors to provide access to the forensics context upon access to the at least one security threat.

28. The computer readable medium of claim 26, further comprising instructions to cause the one or more processors to assign a security event ID to the at least one security threat.

29. The computer readable medium of claim 28, wherein data relating to the at least one security threat is stored in a flow record table, the flow record table comprising a field for the security event ID.

30. The computer readable medium of claim 29, wherein the flow record table further comprises a field for header metadata and a field for application ID.

31. The computer readable medium of claim 29, wherein the forensic context is stored in a forensic context table containing a field for the security event ID.

32. The computer readable medium of claim 31, wherein the security event ID assigned to the at least one security threat is used for the forensic context relating to the at least one security threat.

33. The computer readable medium of claim 26, wherein the forensic context comprises one or more of application metadata, endpoint processes, external host connections, internal host connections, and data flow records stored in one or more flow record files.

34. The computer readable medium of claim 26, further comprising instructions to cause the one or more processors to determine if the security threat is a security event.

35. The computer readable medium of claim 34, wherein network forensic context is obtained for the security threat, only when the security threat is determined to be a security event.

36. The computer readable medium of claim 34, further comprising instructions to cause the one or more processors to determine if the security event is recursive and to store recursive forensic context for the security event if it is determined to be recursive.

37. A network device configured to perform analysis of network traffic, the network device comprising:
one or more processors;
one or more network communication interfaces; and
a memory communicatively coupled to the one or more processors, wherein the memory stores instructions to cause the one or more processors to:
receive network packets from the one or more communication interfaces, the network packets associated with a network flow of data;
monitor the flow of data to identify at least one security threat;
obtain network forensics context relating to the at least one security threat; and
store the at least one security threat and the related network forensics context in the memory.

38. The network device of claim 37, wherein monitoring of the flow of data comprises deep packet inspection.

39. The network device of claim 37, wherein the forensic context comprises one or more of application metadata, endpoint processes, external host connections, internal host connections, and data flow records stored in one or more flow record files.

40. The network device of claim 37, wherein the instructions further cause the one or more processors to enable a user to determine types of forensics context stored for the at least one security threat.

41. The network device of claim 37, wherein the instructions further cause the one or more processors to provide a user interface, wherein the user interface can be used to view the at least one security threat and its' stored forensic context.

42. The network device of claim 41, wherein the user interface can be used to take an action with respect to the at least one security threats.

43. The network device of claim 42, wherein any action taken with respect to the at least one security threat is also taken with respect to the security threat's forensic context.

44. The network device of claim 37, wherein the instructions further cause the one or more processors to determine if the security threat is a security event and only obtain forensic context relating to the security threat if it is determined that the security threat is a security event.

45. A method, comprising the steps of:
receiving network packets from one or more communication interfaces at a device configured to perform network traffic monitoring, the network packets associated with a network flow of data;
monitoring the flow of data to identify at least one security threat;
obtaining network forensics context relating to the at least one security threat; and
storing the at least one security threat and the related network forensics context in a memory.

46. The method of claim 45, further comprising the steps of providing a user interface screen for viewing the at least one security threat and the forensic context.

47. The method of claim 46, wherein the user interface is configured to enable management of the at least one security threat and the forensic context.

48. The method of claim 45, further comprising the steps of determining if the at least one security threat is a security event and obtaining forensic context relating to the at least one security and storing the at least one security threat and the related forensic context only if the security threat is determined to be a security event.

49. The method of claim 45, further comprising the steps of determining if the security threat is a security event.

50. The method of claim 45, wherein the network forensic context is obtained for the security threat only when the security threat is determined to be a security event.
